(19) United States
(12) Patent Application Publication
(10) Pub. No.: US 2018/0044973 A1
(43) Pub. Date: Feb. 15, 2018

(54) GARAGE DOOR RE-FACING SYSTEM

(71) Applicant: LOUISIANA-PACIFIC CORPORATION, Nashville, TN (US)

(72) Inventor: ADINA BARNES, NASHVILLE, TN (US)

(21) Appl. No.: 15/677,932

(22) Filed: Aug. 15, 2017

Related U.S. Application Data
(60) Provisional application No. 62/375,083, filed on Aug. 15, 2016.

(51) Int. Cl. E06B 3/70

(52) U.S. Cl. CPC E06B 3/7001; E06B 2003/7044

(57) ABSTRACT

A system for updating or upgrading onsite the outside or inside faces, or both, of a garage door, such as, but not limited to, a standard steel, aluminum, plastic or vinyl sectional garage door, without painting or replacing the entire door. The system includes a plurality of dimensional overlay pieces, which may be cut to width and length and thickness. The overlay pieces may comprise wood, wood-based products, OSB, plastic, vinyl, similar materials, or combinations thereof. The overlay pieces are applied over and fastened to the exterior or interior faces of the garage door.

This application claims benefit of and priority to U.S. Provisional Application No. 62/375,083, filed Aug. 15, 2016, which is incorporated herein in its entirety by specific reference for all purposes.

### FIELD OF INVENTION

This invention relates to a system for re-facing a garage door.

### BACKGROUND OF THE INVENTION

Garage doors are often the focal point of a home. Garage doors frequently cover the most outside surface area on a side of a home, and the appearance of the garage door can substantially add or detract from the home's curb appeal. To upgrade the appearance of an older or dated garage door, the homeowner currently is limited to painting the door, or replacing it entirely.

### SUMMARY OF INVENTION

In various exemplary embodiments, the present invention comprises a system for updating or upgrading onsite the outside or inside face of a garage door, such as, but not limited to, a standard steel, aluminum, plastic or vinyl sectional garage door, without painting or replacing the entire door. The garage door may be re-faced prior to or after installation. The present invention comprises a plurality of dimensional overlay panels and dimensional overlay pieces, which may be pre-cut to width and length. The overlay panels and pieces may comprise wood, wood-based products, OSB, plastic, vinyl, similar materials, or combinations thereof.

The overlay panels and pieces are applied over and fastened to the exterior or interior, or both, of an existing garage door. Fastening means comprise chemical adhesives or glues, mechanical fasteners (e.g., bolts, nails, staples, or screws), or combinations thereof. Examples of adhesives or glues that may be used include, but are not limited to, adhesive caulk, silicone, synthetic rubber, acrylic latex, and silyl-modified polymer (SMP) adhesives and sealants.

The overlay panels and pieces are components of an overall design, and may be numbered or coded to be installed in a certain order or position (an instruction or design sheet may be used during installation to ensure overlay pieces are installed in the proper order or location). The overlay panels and pieces may comprise a full-face or partial or trimmed design, and the system may comprise any of a plurality of options with different designs, colors, textures, imprinting, patterns, or the like. The overlay pieces may be natural finish, colored, primed for painting or staining, or may be pre-painted or pre-stained. Touch-up paint may also be provided to cover any defects or gaps in the overlay pieces.

The system may be provided or sold as a pre-packaged kit for different size doors, or as separate components, with pre-determined materials, colors, designs, texture, connection methods, and the like, from a library of colors or designs. The system also may be provided or sold as a partial custom product, where a purchaser orders the desired combination of size, material, design, color, texture, and the like. In some embodiments, the purchaser may provide a particular design, or other details, to a system provider for creation as a truly custom product.

### BRIEF DESCRIPTION OF THE DRAWINGS

FIG. 1 shows a front view of a garage door with re-facing overlays and panels partially installed in accordance with an exemplary embodiment of the present invention.

FIG. 2 shows an arrangement of overlay pieces in accordance with an exemplary embodiment of the present invention.

FIG. 3 shows another arrangement of overlay pieces in accordance with another exemplary embodiment of the present invention.

FIG. 4 shows another arrangement of overlay pieces in accordance with another exemplary embodiment of the present invention.

FIG. 5 shows another arrangement of overlay pieces in accordance with another exemplary embodiment of the present invention.

FIG. 6 shows a cross-sectional view of an overlay piece.

FIGS. 7-10 show additional arrangements of overlay pieces.

### DETAILED DESCRIPTION OF EXEMPLARY EMBODIMENTS

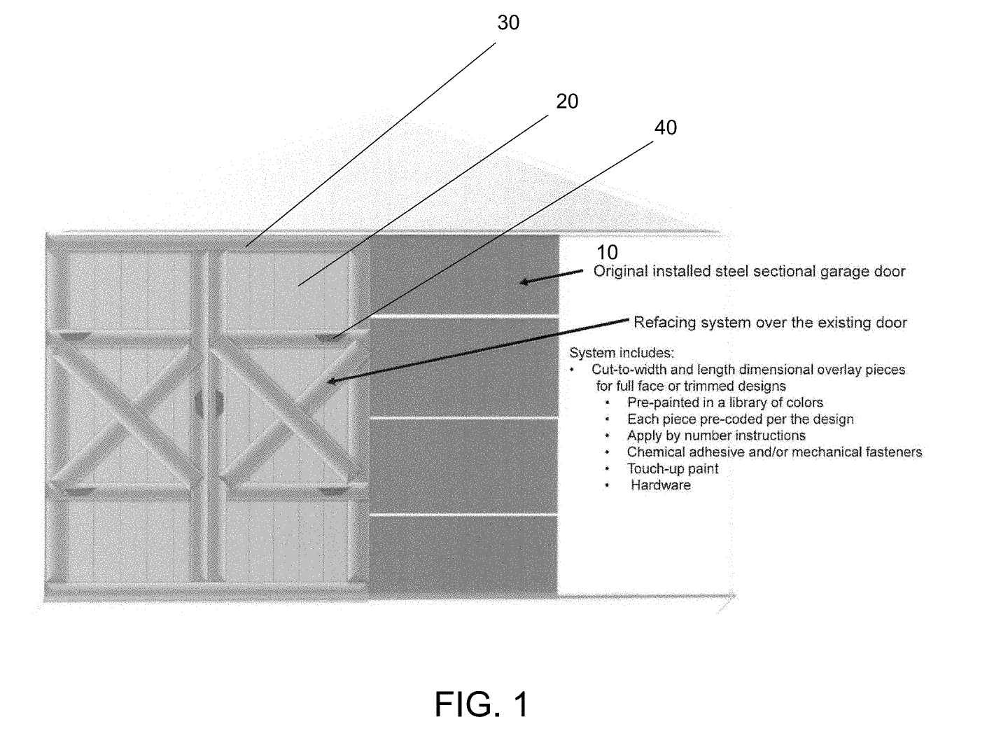

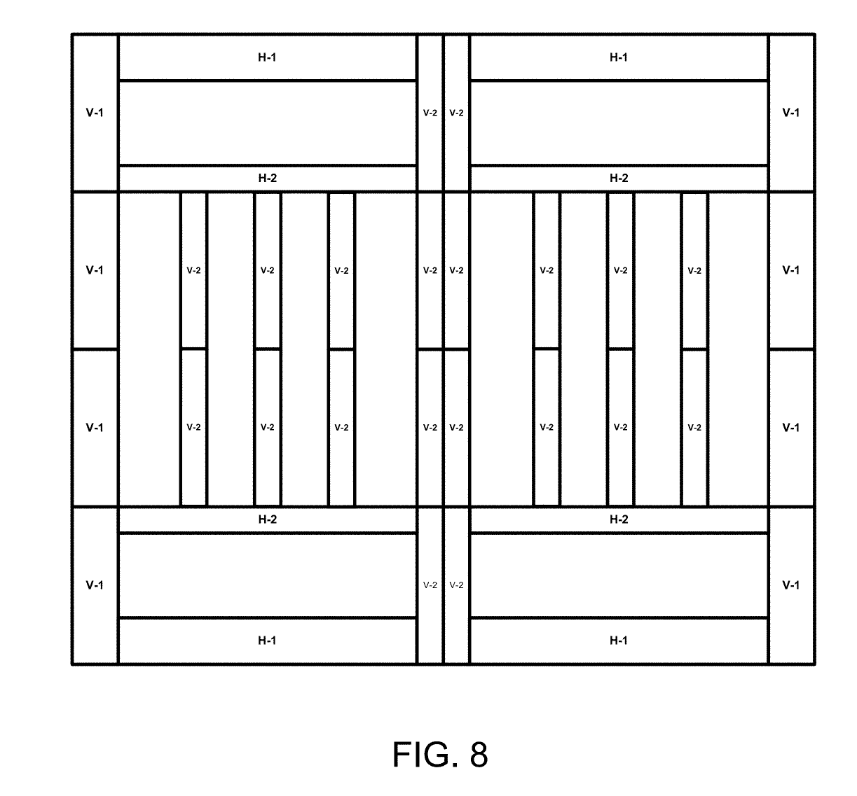

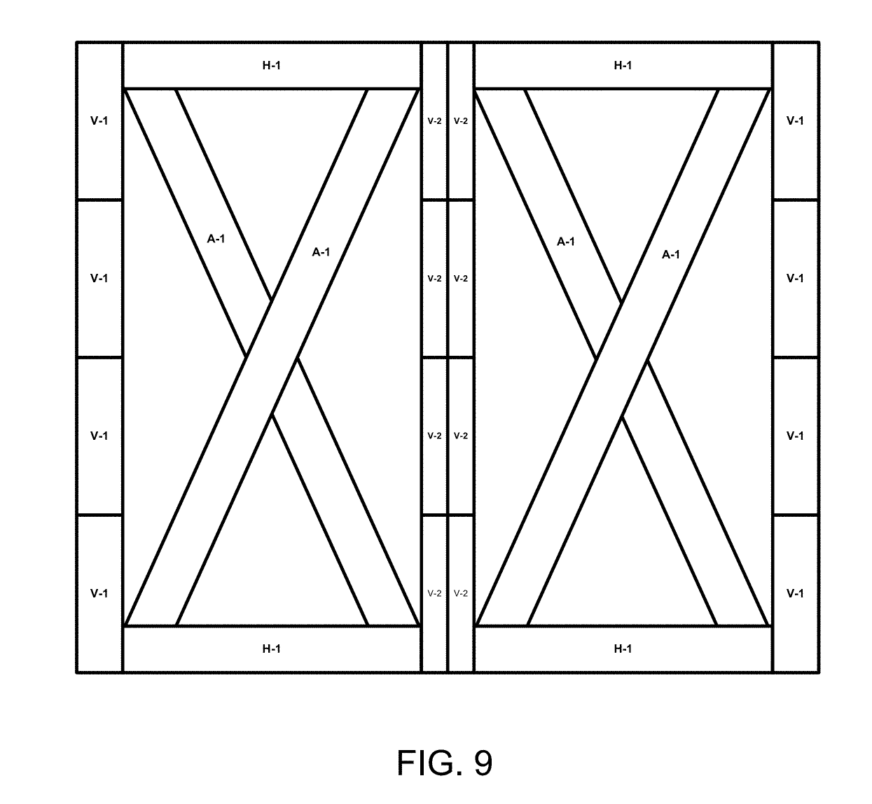

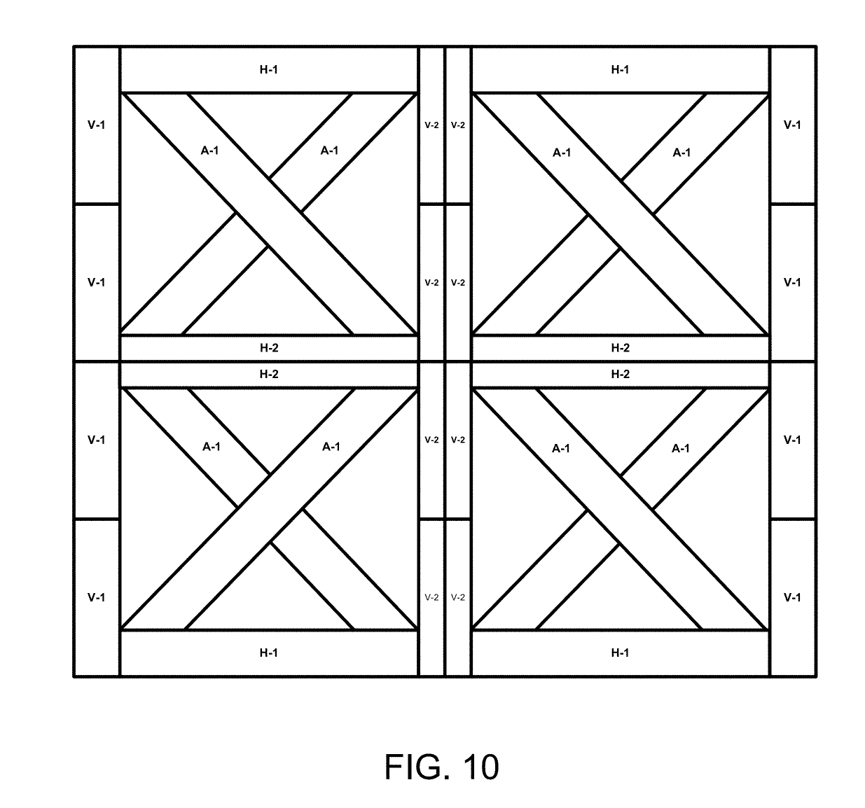

In various exemplary embodiments, as seen in FIGS. 1-10, the present invention comprises a system for updating or upgrading onsite the outside or inside face of a previously installed garage door 10, such as, but not limited to, a standard steel, aluminum, plastic or vinyl sectional garage door, without painting or replacing the entire door. The garage door may be re-faced prior to or after installation. The present invention comprises a plurality of dimensional overlay panels 20 and dimensional overlay pieces 30, which may be cut to width and length. The overlay panels and pieces may comprise wood, wood-based products, OSB, plastic, vinyl, similar materials, or combinations thereof.

The overlay panels and pieces are applied over and fastened to the exterior or interior face, or both of an existing garage door. Fastening means comprise chemical adhesives or glues, mechanical fasteners (e.g., bolts, nails, staples or screws), or combinations thereof. Examples of adhesives or glues that may be used include, but are not limited to, adhesive caulk, silicone, synthetic rubber, acrylic latex, and silyl-modified polymer (SMP) adhesives and sealants.

The overlay panels and pieces are components of an overall design, and may be numbered or coded to be installed in a certain order or position (an instruction or design sheet may be used during installation to ensure overlay pieces are installed in the proper order or location). The overlay panels and pieces may comprise a full-face or partial or trimmed design, such as, but not limited to, the carriage style or courtyard style designs shown in FIGS. 1-6. Thus, a plurality of vertical, horizontal or angled overlay pieces 30 may be installed on the original door 30 with the original door showing as the background. Alternatively, a backing overlay panel 20 may be installed on and covering the face of the original door, with the plurality of overlay pieces 30 installed on the backing overlay.

In various exemplary embodiments, the present invention is configured to be applied to garage doors of various sizes, including, but not limited to, height and width of 16 feet×16 feet, 8 feet×7 feet, 8 feet×8 feet, 9 feet by 7 feet, and 9 feet by 8 feet. The overlay panels and pieces are provided in various thicknesses, widths and lengths to complete a particular arrangement or design. In several embodiments, the overlay pieces are approximately 0.4 to 0.5 inches in thickness, and 3.5 inches and 5.5 inches in width, based on placement in the design.

In several exemplary embodiments, the overlay pieces comprise several standard types of vertical, horizontal, and angled overlay pieces of pre-established width and length/height, as described in Table 1:

TABLE 1

| Overlay | Width | Length/Height |
|---|---|---|
| Type | (in) | (in) |
| V-1(S) | 5.5 | 20.8 |
| V-1(L) | 5.5 | 24 |
| V-2(S) | 3.5 | 20.8 |
| V-2(L) | 3.5 | 24 |
| V-3(S) | 3.5 | 15.3 |
| V-3(L) | 3.5 | 18.5 |
| H-1(S) | 5.5 | 38.813 |
| H-1(L) | 5.5 | 44.813 |
| H-2(S) | 3.5 | 38.813 |
| H-2(L) | 3.5 | 44.813 |
| A-1(S) | 5.5 | 68.86 |
| A-1(M) | 5.5 | 72.409 |
| A-1(L) | 5.5 | 80.205 |
| A-1(XL) | 5.5 | 81.174 |

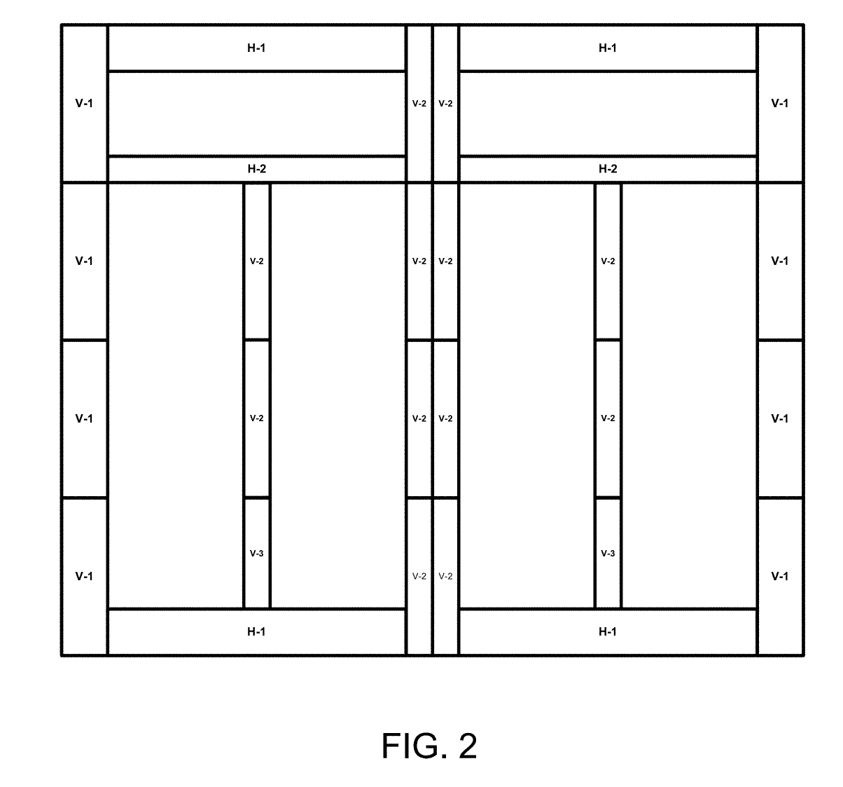

FIGS. 2-5 and 7-10 show examples of arrangements of these standard overlay pieces in accordance with various exemplary embodiments of the present invention. Each arrangement uses a different combination of vertical overlay pieces (V-1, V-2, V-3), horizontal overlay pieces (H-1, H-2), and angled overlay pieces (A-1). Not all types of pieces are used in every arrangement, and the number of pieces of a particular type may differ between arrangements. Other arrangements using different combinations of overlay pieces, or different sizes of overlay pieces, are within the scope of this invention.

FIG. 2 shows an example of an arrangement with three types of vertical overlay pieces and two types of horizontal overlay pieces. The pieces arranged around the outside perimeter (V-1, H-1) are wider than the other pieces. Exemplary quantities of respective pieces are provided in Table 2 below:

TABLE 2

| Garage | | |
|---|---|---|
| Door Size | | |
| (ft) | Overlay | |
| (h × w) | Type | Quantity |
| 8 × 7 | V-1(S) | 8 |
| | V-2(S) | 12 |
| | V-3(S) | 2 |
| | H-1(S) | 4 |
| | H-2(S) | 2 |
| 8 × 8 | V-1(L) | 8 |
| | V-2(L) | 12 |
| | V-3(L) | 2 |
| | H-1(S) | 4 |
| | H-2(S) | 2 |
| 9 × 7 | V-1(S) | 8 |
| | V-2(S) | 12 |
| | V-3(S) | 2 |
| | H-1(L) | 4 |
| | H-2(L) | 2 |
| 9 × 8 | V-1(L) | 8 |
| | V-2(L) | 12 |
| | V-3(L) | 2 |
| | H-1(L) | 4 |
| | H-2(L) | 2 |

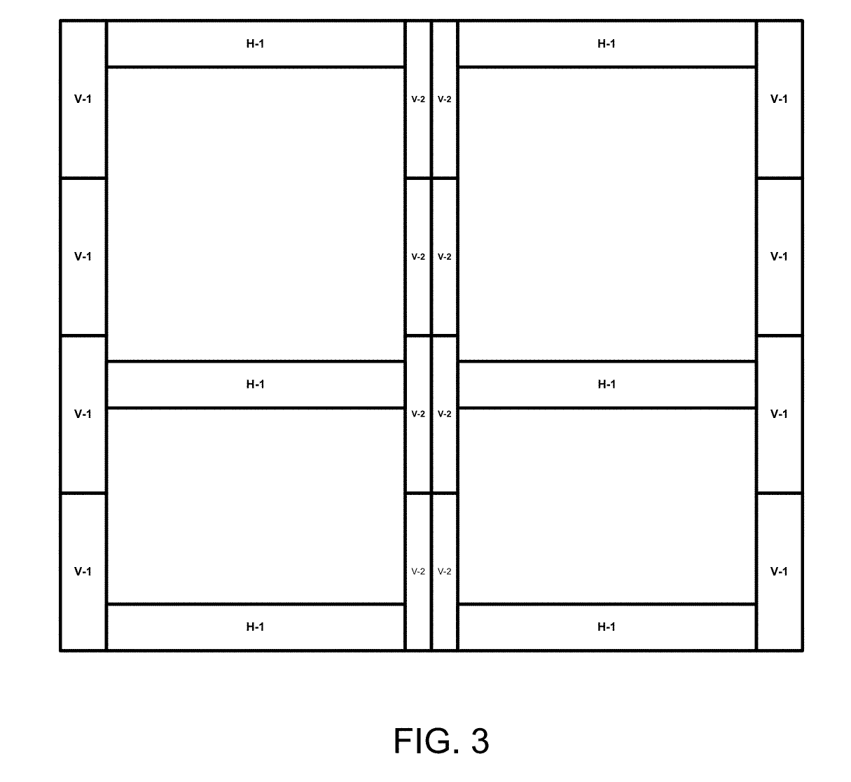

FIG. 3 shows an example of another arrangement with two types of vertical pieces and one type of horizontal pieces. The pieces arranged around the outside perimeter and horizontally across the center (V-1, H-1) are wider than the other pieces (B). Exemplary quantities of respective pieces are provided in Table 3 below:

TABLE 3

| Garage | | |
|---|---|---|
| Door Size | | |
| (ft) | Overlay | |
| (h × w) | Type | Quantity |
| 8 × 7 | V-1(S) | 8 |
| | V-2(S) | 8 |
| | H-1(S) | 6 |
| 8 × 8 | V-1(L) | 8 |
| | V-2(L) | 8 |
| | H-1(S) | 6 |
| 9 × 7 | V-1(S) | 8 |
| | V-2(S) | 8 |
| | H-1(L) | 6 |
| 9 × 8 | V-1(L) | 8 |
| | V-2(L) | 8 |
| | H-1(L) | 6 |

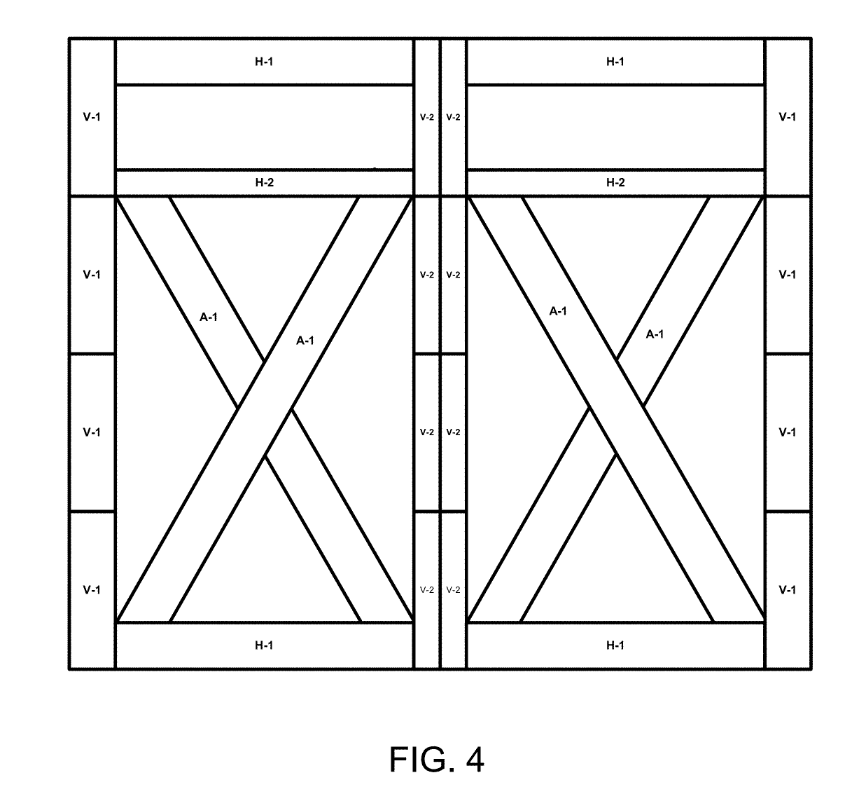

FIG. 4 shows an example of another arrangement with two types of vertical pieces, one type of angled pieces, and two types of horizontal pieces. The pieces arranged around the outside perimeter and angled across the center (V-1, H-1, A-1) are wider than the other pieces. Exemplary quantities of respective pieces are provided in Table 4 below:

TABLE 4

| Garage | | |
|---|---|---|
| Door Size | | |
| (ft) | Overlay | |
| (h × w) | Type | Quantity |
| 8 × 7 | V-1(S) | 8 |
| | V-2(S) | 8 |
| | A-1(S) | 4 |
| | H-1(S) | 4 |
| | H-2(S) | 2 |
| 8 × 8 | V-1(L) | 8 |
| | V-2(L) | 8 |
| | A-1(XL) | 4 |
| | H-1(S) | 4 |
| | H-2(S) | 2 |
| 9 × 7 | V-1(S) | 8 |
| | V-2(S) | 8 |
| | A-1(M) | 4 |
| | H-1(L) | 4 |
| | H-2(L) | 2 |
| 9 × 8 | V-1(L) | 8 |
| | V-2(L) | 8 |
| | A-1(L) | 4 |
| | H-1(L) | 4 |
| | H-2(L) | 2 |

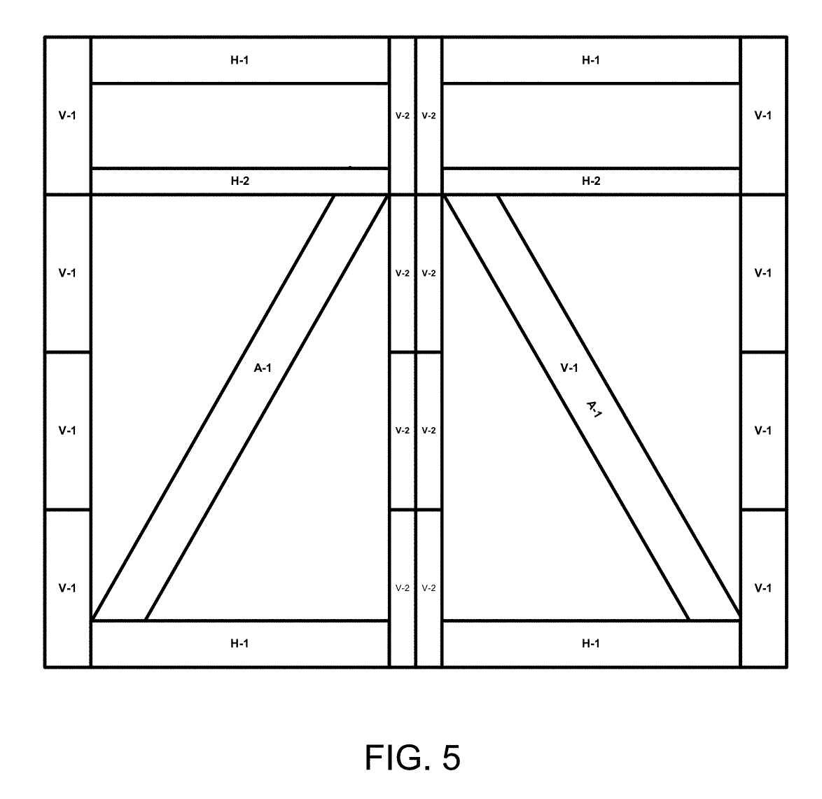

FIG. 5 shows an example of another arrangement with two types of vertical pieces, one type of angled pieces, and two types of horizontal pieces. The pieces arranged around the outside perimeter and angled across the center (V-1, H-1, A-1) are wider than the other pieces. Exemplary quantities of respective pieces are provided in Table 5 below:

TABLE 5

| Garage | | |
|---|---|---|
| Door Size | | |
| (ft) | Overlay | |
| (h × w) | Type | Quantity |
| 8 × 7 | V-1(S) | 8 |
| | V-2(S) | 8 |
| | A-1(S) | 2 |
| | H-1(S) | 4 |
| | H-2(S) | 2 |
| 8 × 8 | V-1(L) | 8 |
| | V-2(L) | 8 |
| | A-1(XL) | 2 |
| | H-1(S) | 4 |
| | H-2(S) | 2 |
| 9 × 7 | V-1(S) | 8 |
| | V-2(S) | 8 |
| | A-1(M) | 2 |
| | H-1(L) | 4 |
| | H-2(L) | 2 |
| 9 × 8 | V-1(L) | 8 |
| | V-2(L) | 8 |
| | A-1(L) | 2 |
| | H-1(L) | 4 |
| | H-2(L) | 2 |

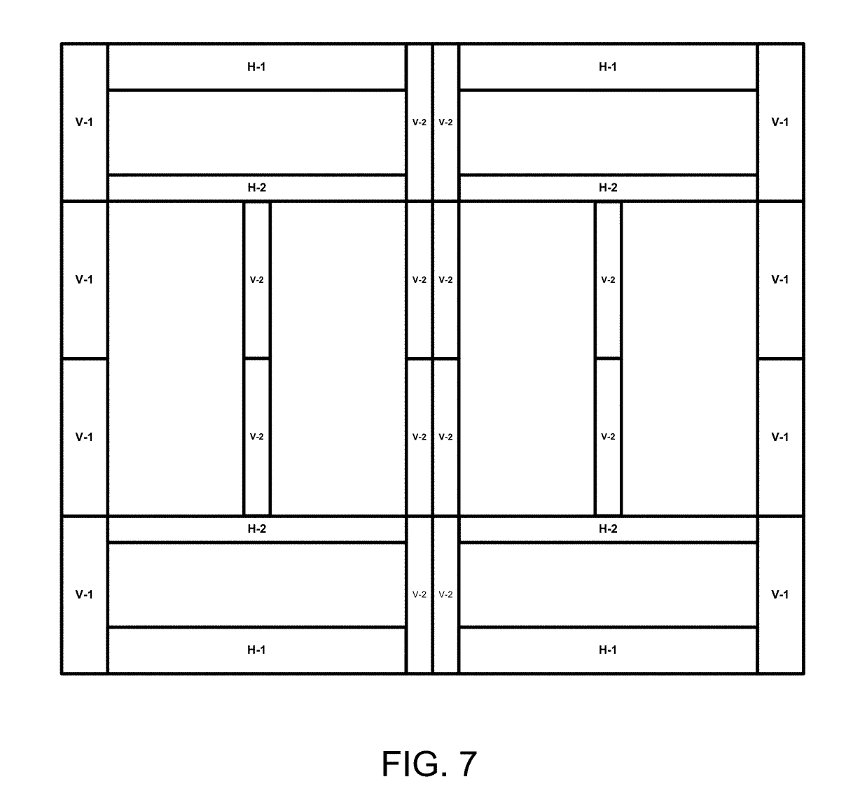

FIGS. 7-10 show additional arrangements of overlay pieces. The number and placement of pieces are evident from the figures.

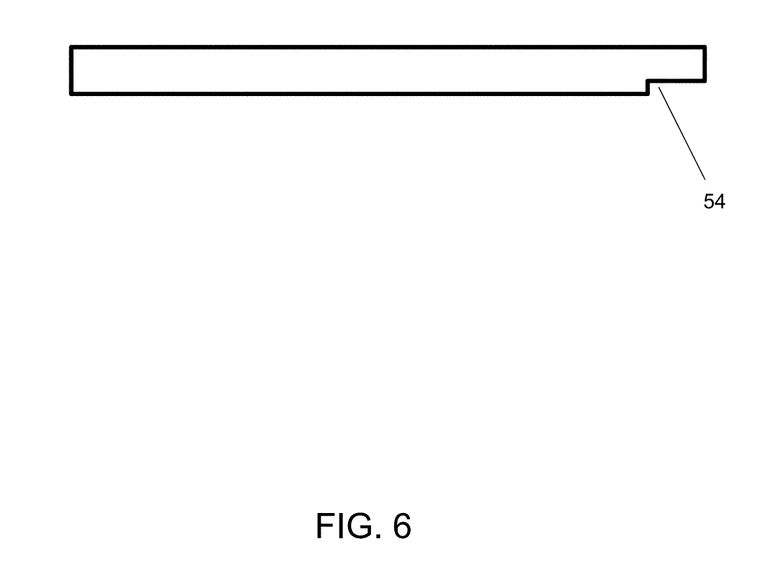

FIG. 6 shows a cross-section view across an embodiment of a V-1 overlay piece (i.e., an outside vertical piece or, endcaps), as seen in FIGS. 3-6. The outside of each piece comprises a notch 54 as shown that runs along the length of the outside edges of the vertical pieces as installed. This provides a flush fit for formed steel along the edges on the front of some types of garage doors.

The system may comprise any of a plurality of options with different designs, colors, textures, imprinting, patterns, connection methods, or the like. For example, FIG. 1 shows an example of a backing overlay panel 20 with the image of a planked wood door, while the overlay pieces are imprinted with accents 40, such as handles or iron supports or hinges. The overlay pieces may be natural finish, colored, primed for painting or staining, or may be pre-painted or pre-stained. Touch-up paint may also be provided to cover any defects or gaps in the overlay pieces.

The system may be provided or sold as a pre-packaged kit for different size doors, or as separate components, with pre-determined materials, colors, designs, texture, connection methods, and the like, from a library of colors or designs. The system also may be provided or sold as a partial custom product, where a purchaser orders the desired combination of size, material, design, color, texture, and the like. In some embodiments, the purchaser may provide a particular design, or other details, to a system provider for creation as a truly custom product.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for upgrading an installed garage door, comprising:
a plurality of overlay pieces of a first type pre-cut to a width and a length;
a plurality of overlay pieces of a second type pre-cut to a width and a length; and
a plurality of overlay pieces of a third type pre-cut to a width and a length;
wherein each type of overlay piece differs in width or length, or both, from other types of overlay pieces;
further wherein the plurality of overlay pieces of the first, second and third types are configured to be affixed directly or indirectly to a garage door in a pre-established ordered arrangement.

2. The system of claim 1, wherein each overlay piece is numbered or coded in order of affixation.

3. The system of claim 1, wherein the overlay pieces are affixed by adhesive.

4. The system of claim 3, wherein the adhesive is one or more of a silicone, synthetic rubber, acrylic latex, or silyl-modified polymer (SMP) adhesive.

5. The system of claim 1, further comprising at least backing overlay panel, wherein said at least one backing overlay panel is affixed to the garage door and the plurality of overlay pieces are affixed to the at least one backing overlay panel.

6. The system of claim 1, wherein the first and second types of overlay pieces are arranged vertically and the third type of overlay pieces are arranged horizontally.

7. The system of claim 6, wherein there are 8 overlay pieces of the first type, 8 overlay pieces of the second type, and 6 overlay pieces of the third type.

8. The system of claim 1, further comprising:
a plurality of overlay pieces of a fourth type pre-cut to a width and a length; and
a plurality of overlay pieces of a fifth type pre-cut to a width and a length;
wherein the fourth type of overlay pieces are arranged vertically, and the fifth type of overlay pieces are arranged horizontally.

9. The system of claim 8, wherein there are 8 overlay pieces of the first type, 12 overlay pieces of the second type, 4 overlay pieces of the third type, 2 overlay pieces of the fourth type, and 2 overlay pieces of the fifth type.

10. The system of claim 1, further comprising:
a plurality of overlay pieces of a fourth type pre-cut to a width and a length; and
a plurality of overlay pieces of a fifth type pre-cut to a width and a length;
wherein the fourth type of overlay pieces are arranged at an angle with respect to the horizontally and vertically arranged overlay pieces, and the fifth type of overlay pieces are arranged horizontally.

11. The system of claim 10, wherein there are 8 overlay pieces of the first type, 8 overlay pieces of the second type, 4 overlay pieces of the third type, 2 overlay pieces of the fourth type, and 4 overlay pieces of the fifth type.

12. The system of claim 10, wherein there are 8 overlay pieces of the first type, 8 overlay pieces of the second type, 4 overlay pieces of the third type, 2 overlay pieces of the fourth type, and 2 overlay pieces of the fifth type.

13. The system of claim 1, where the overlay pieces are pre-painted or pre-stained prior to affixation.

14. The system of claim 1, wherein some or all of the overlay pieces are imprinted with a design.

15. The system of claim 1, where the plurality of overlay pieces of each type are cut to a thickness.

16. A kit for re-facing a garage door, comprising:
a plurality of overlay pieces of a first type pre-cut to a width and a length;
a plurality of overlay pieces of a second type pre-cut to a width and a length; and
a plurality of overlay pieces of a third type pre-cut to a width and a length; and
means for affixing said plurality of overlay pieces of the first, second and third types are configured to be affixed directly or indirectly to a garage door in a pre-established ordered arrangement;
wherein each type of overlay piece differs in width or length, or both, from other types of overlay pieces;
further wherein each overlay piece is numbered or coded in order of affixation.

17. The kit of claim 16, further comprising touch-up paint.

18. The kit of claim 17, wherein said means for affixing comprises adhesive, mechanical fasteners, or a combination thereof.

19. The kit of claim 16, further comprising at least a plurality of overlay pieces of a fourth type pre-cut to a width and a length.

20. The kit of claim 16, further comprising at least backing overlay panel.

21. The kit of claim 16, wherein some or all of the overlay pieces are pre-painted, pre-stained, or imprinted with a design.
